(19) United States
(12) Patent Application Publication
(10) Pub. No.: US 2020/0008353 A1
(43) Pub. Date: Jan. 9, 2020

(54) Greenhouse harvester of cannabis

(71) Applicant: ASRI y. Ruben, Tucson, AZ (US)

(72) Inventor: ASRI y. Ruben, Tucson, AZ (US)

(21) Appl. No.: 15/998,117

(22) Filed: Jul. 3, 2018

(51) Int. Cl. A01D 41/127; A01F 7/02; B62D 55/04; A01D 67/00

(52) U.S. Cl. CPC A01D 41/1274; A01F 7/02; A01D 33/10; A01D 67/00; B62D 55/04

(57) ABSTRACT

A harvester for bedded plants having a driving mechanism having two sets of wheels or tracks positioned on opposing sides of a plant bed. An adjustable “U” shaped frame allows the legs connected to the wheels/tracks to be elongated or shortened with the cross member also being elongated to meet the demands of the particular plant bed. Secured to the cross member is a harvest mechanism which grips and cuts the plants stock, removes the flowers and or leaves, and then deposits the harvested material into a receiving bin.

This is a continuation-in-part of U.S. patent application Ser. No. 15/932,722 filed on Apr. 12, 2018 and entitled “A Harvester for Cannabis”.

### BACKGROUND OF THE INVENTION

This invention relates to a mechanism to harvest cannabis in field setting.

While traditionally, cannabis has been grown and harvested by hand, with legal advancements within the United States, the demand for cannabis is quickly outstripping the ability for hand tended cannabis to keep pace. The reason that hand-tending is the standard, is that cannabis, unlike almost any other plant, requires a heightened regard for the harvesting. For the cannabis plant, very little of the plant is not useful for one purpose or the other.

Traditional mechanized methods for agricultural growth of cannabis quickly run into problems with the harvesting process as the existing mechanisms cannot be used efficiently. They are both clumsy and fail to address the special needs that cannabis requires.

It is clear that there is a need to mechanically harvest field grown cannabis.

### SUMMARY OF THE INVENTION

The invention provides a mechanism which permits the mechanized harvesting of cannabis plant parts from an agricultural field. The mechanism is ideally self-propelled although other embodiments are either drawn or pushed through the agricultural field.

In this regard, the invention uses the mobility commonly found in combine harvesters. Those of ordinary skill in the art readily recognize a variety of structures which are applicable here, including, but not limited to those described in: U.S. Pat. No. 9,763,391, entitled “Combine Harvester with Top-Located Cleaning Arrangement” issued to Missotten et al. on Sep. 19, 2017; U.S. Pat. No. 5,290,201, entitled “Combine with Moveable Body and Tandem Drive Wheels” issued to Tesker on Mar. 1, 1994; and U.S. Pat. No. 9,756,787, entitled “Combine Harvester” issued to Heitmann et al. on Sep. 12, 2017; both of which are incorporated hereinto by reference.

The mechanism contains a gripping mechanism which secures the stem of the cannabis plant as the mechanism moves through the field. Gripping is ideally done using rubber “fingers” located on a pair of wheels which rotate the stem into the fingers while the stem is being cut from the root. Ideally the stem is cut approximately three inches from the soil/root.

In another embodiment, the cutting of the stem is done after the root has been removed from the soil allowing the root to be harvested. The removal of the root from the soil is ideally done by pulling the stem upwards to dislodge the root from the soil. A variation of the invention provides for the root removal using a subterranean wedge traveling through the soil to dislodge the root from the soil.

In either embodiment, once the stem has been cut, the flowers on the stem are removed and placed in a designated bin for collection of the flowers. Cannabis flowers are one of the most valuable parts of the cannabis plant.

Those of ordinary skill in the art readily recognize a variety of mechanisms which will remove the flower including that described in U.S. Pat. No. 6,237,475, entitled “Machine for Peeling Pears, Removing their Core, and cutting them into Segments” issued to Ascari, et al. on May 29, 2001, incorporated hereinto by reference.

The now flowerless and rootless stem then has the leaves removed for collection in another bin. The leaves from the cannabis plant are highly prized and provide another economic benefit to the grower.

Those of ordinary skill in the art, readily recognize a variety of techniques which may be used to remove leaves from the stem, including, but not limited to those described in: U.S. Pat. No. 9,807,937, entitled “Agricultural Harvester with Improved Rotor Transition Geometry” issued to Flickinger et al. on Nov. 7, 2017; U.S. Pat. No. 5,103,623, entitled “Apparatus and Method for Harvesting Agricultural Produce” issued to Herrett on Apr. 14, 1992; and, U.S. Pat. No. 9,854,742, entitled “Crop Processing Apparatus in a Combine Harvester” issued to Bilde on Jan. 2, 2018; all of which are incorporated hereinto by reference.

At this point, the stems are “naked”, without roots, flowers, or leaves. The naked stems are then baled and either placed into their own designated bin or, preferably are deposited back into the agricultural field. The stems also provide an economic advantage and are used for a variety of products including hemp.

Baling of the bundles is well known in the art and includes such techniques as described in: U.S. Pat. No. 4,813,348, entitled “Machine for Forming Cylindrical Bales of Crop” issued to Frerich et al. on Mar. 21, 1989; and, U.S. Pat. No. 8,434,289, entitled “Sensor for Detection of Wrapping on Bale” issued to Smith et al. on Mar. 7, 2013; both of which are incorporated hereinto by reference.

In the preferred embodiment, each bale is weighed and a label having its weight is attached to the bale. The weight is also added to a running total so that production of the stems is monitored.

In like fashion, another embodiment of the invention weights each of the different bins (roots, flowers, and leaves) in a running fashion to assure that the crop is not tampered with by the operator or others. This running tally is also useful for reporting to government entities who are monitoring the production of cannabis.

Those of ordinary skill in the art readily recognize a variety of mechanisms which may be utilized to weight the bales of stems as well as the bins, including, but not limited to: U.S. Pat. No. 8,857,745, entitled “Agricultural Spreader Control” issued to Aral on Oct. 14, 2014; U.S. Pat. No. 9,347,818, entitled “Automated Collection and Scale System” issued to Curotto on May 24, 2016; and, U.S. Pat. No. 9,694,973, entitled “Electrical Powered Weight and Fullness Level System” issued to Ullrich et al. on Jul. 4, 2017; all of which are incorporated hereinto by reference.

Another embodiment of the invention is adapted for a plant bed or box to allow automated harvesting of the crop. In this embodiment, a harvester for the bedded plants has a driving mechanism having two sets of wheels or tracks positioned on opposing sides of a plant bed. An adjustable “U” shaped frame allows the legs connected to the wheels/tracks to be elongated or shortened. The cross member is also selectively elongated to meet the demands of the particular plant bed dimensions. Secured to the cross member is a harvest mechanism which grips and cuts the plants stock, removes the flowers and or leaves, and deposits the harvested material into a receiving bin.

The harvester is positioned and adjusted to meet the actual bed with the wheels on the outside of the plant bed. The harvesting mechanism(s) is/are aligned with the rows of crop (cannabis in the preferred application) and an operator using a handheld control, directs the harvester down the plant bed harvesting the crop.

Handheld controls are well known in the art and include a variety of mechanisms, such as, but not limited to: U.S. Pat. No. 9,932,058, entitled “Scaffolding Transport Cart” issued to Holloway, et al. on Apr. 3, 2018; U.S. Pat. No. 9,939,811, issued to Fitzpatrick on Apr. 10, 2018; U.S. Pat. No. 9,969,478, issued to Mazin on May 15, 2018; and United States patent publication number 20180134206, entitled “Remote Controlled Cart” by Grivettie et al.; all of which are incorporated hereinto by reference.

As the frame/tractor passes over the bed, the harvesting mechanism processes the plants in the plant bed. The stems are cut as outlined above, the flowers are removed from the stem. The removed flowers are placed into a bin for retrieval. In the preferred embodiment, the flower bin is located outside the plant bed and is periodically emptied using a bottom drop door.

In a like manner, the harvesting mechanism, in some embodiments, has a mechanism to remove the leaves from the stem which are then deposited into a leaf bin. The leaf bin is ideally located outside the plant bed and has a bottom drop door for removal of the harvested leaves.

In one embodiment, the harvesting mechanism is detachable from the cross member or tool bar. This permits the harvesting mechanisms to have preventive-maintenance performed and for repairs to be made. Further, this also allows multiple harvesting mechanism to be placed onto the cross member or tool bar to address multiple rows of plants within the plant bed.

In some embodiments, the denuded stem is bundled and deposited onto the plant bed for later removal.

The invention, together with various embodiments thereof, will be more fully explained by the accompanying drawings and the following descriptions thereof.

### DRAWINGS IN BRIEF

FIGS. 1A and 1B graphically illustrate the preferred embodiment of the invention.

FIG. 2 illustrates the portable nature of the invention.

FIG. 3 is a diagram of the informational flow on the weights for the bins during operation of the mechanism.

FIG. 4 is a top view of the preferred embodiment highlighting the functional components of the invention.

FIG. 5 is a side view of the preferred embodiments illustrating the mechanical structure of the preferred embodiment.

FIGS. 6A and 6B illustrate two alternative bins permitting easy discharge of the collected materials (flowers or leaves).

FIG. 7 illustrates a cross member or tool bar that may be elongated.

### DRAWINGS IN DETAIL

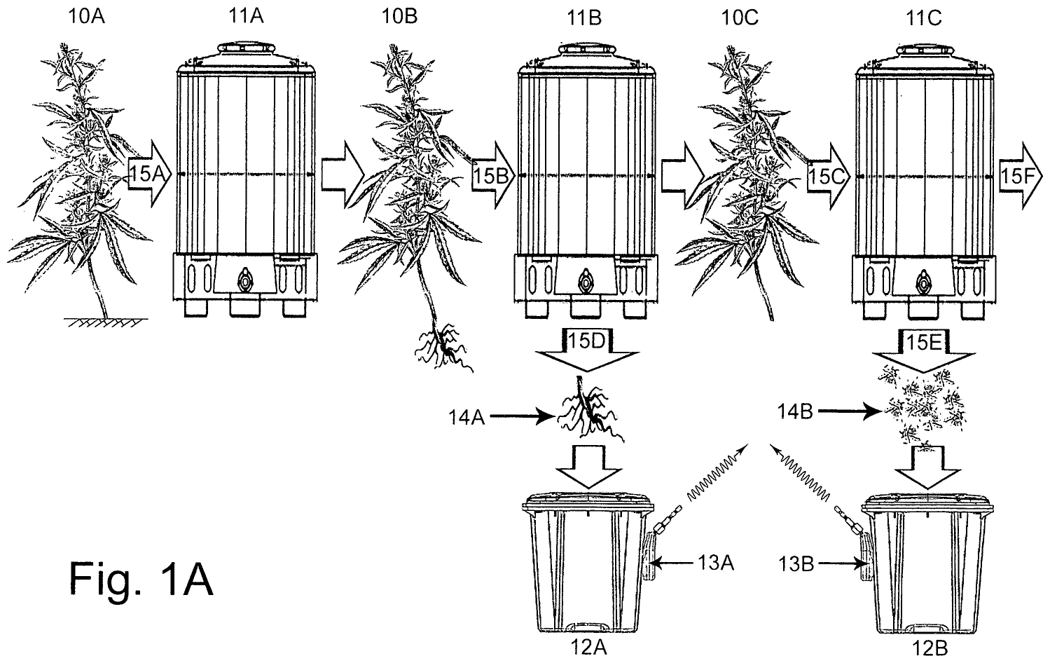

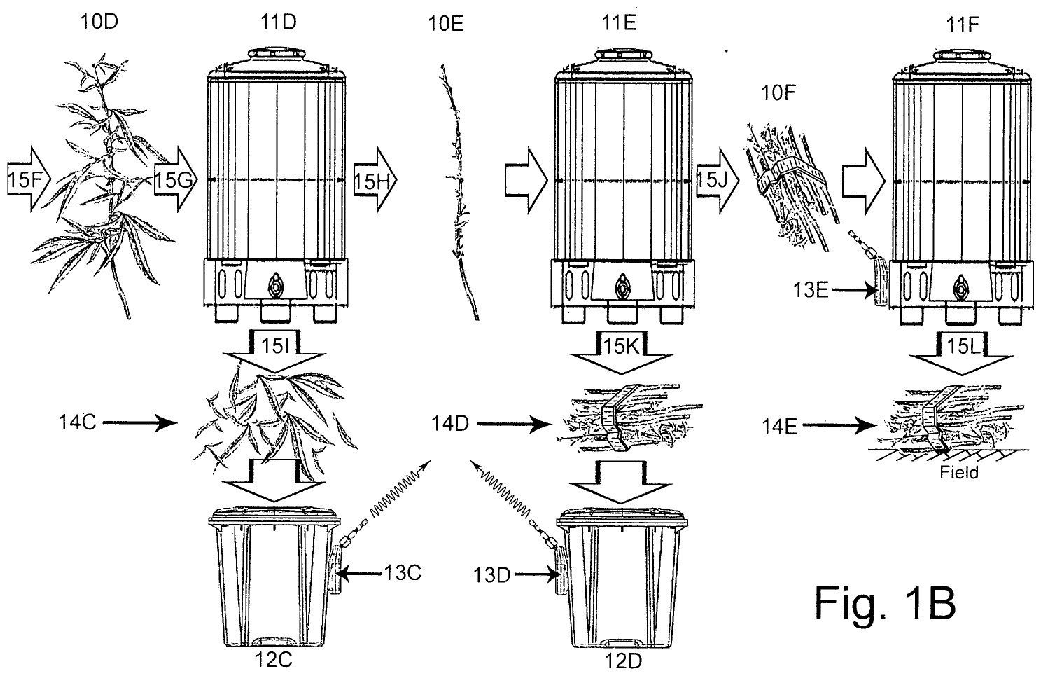

FIGS. 1A and 1B graphically illustrate the preferred embodiment of the invention.

Cannabis plant 10A is grown in an agricultural field. Ideally the plants are arranged as row crops to facilitate mechanized harvesting.

Cannabis plant 10A passes 15A into the removal mechanism 11 which removes, in this embodiment, the entire cannabis plant 10B including the roots from the soil.

The cannabis plant 10B is introduced 15B to the cutting mechanism 11B which cuts the stem of the cannabis plant 10B to remove roots 14A which are delivered, 15D, to root bin 12A. Ideally the cutting of the stem is approximately three inches above the soil line. In some embodiments, this step is not performed until the end of the process.

In some embodiments of the invention, the root is not harvested. In these embodiments the cutting is done within the field without removing the roots from the soil.

A running tally of the weight within root bin 12A is computed and communicated 13A to a remote computer (described in FIG. 3).

Cannabis plant 10C, now devoid of its root, is passed 15C to the deflowering mechanism 11C which removes flowers 14B and deposits the flowers into flower bin 12B. Communication apparatus 13B communicates the weight of the flowers within flower bin 12B to the remote computer.

Cannabis plant 10D (now without its root and the flowers) passes 15F and enters 15G the de-leafing mechanism 11D which removes the leaves 14C from the stem. These leaves 14C are deposited 151 into leaf bin 12C. The weight within leaf bin 12C is communicated to the remote computer 13C.

Cannabis plant 10E, now only a stem, is moved 15H into the bailing mechanism 11E which gathers multiple stems into bundles or bales 10F.

In one embodiment, bundle 14D is deposited 15K into stem bin 12D and the running weight of the bundles is communicated 13D to the remote computer.

In the preferred embodiment, bundle 10B passes 15J into a weight/marking mechanism 11F which weighs the individual bundle and marks the bundle with this weight. The weight is communicated to the remote computer. This weighed and marked bundle 14E is then deposited back onto the agricultural field for later removal.

Ideally the various mechanisms described in FIGS. 1A and 1B are contained, together with the transporting mechanisms, within a single unit allowing a cannabis plant obtained from an agricultural field to yield separated and collected roots, flowers, leaves, and stems.

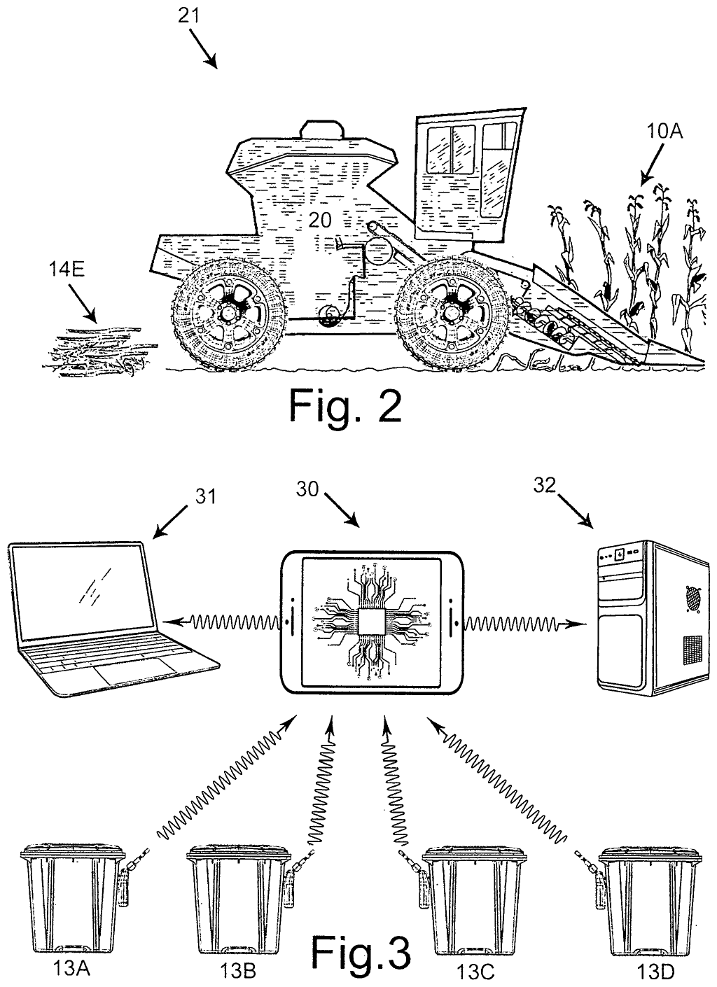

FIG. 2 illustrates the portable nature of the invention.

In the preferred embodiment, the operation of FIGS. 1A and 1B are contained within housing 20 mounted onto harvester 21 which is self-propelled and travels ver the agricultural field collecting the cannabis plants 10A. Within housing 20, the cannabis plant is selectively processed to yield the roots, flowers, and leaves in bins while the bundled stems 14E are left on the agricultural field.

FIG. 3 is a diagram of the informational flow on the weights for the bins during operation of the mechanism.

To monitor the yield from the cannabis crop, computer 30 collects the weights from the various bins: root bin 13A, flower bin 13B, leaf bin 13C, and stem bin 13D (if one is being used). This data is stored in memory 32 and displayed onto screen 31.

This running tally of the crop yield is important not only for the farmer but also is useful for governmental entities who are tasked with monitoring the yield.

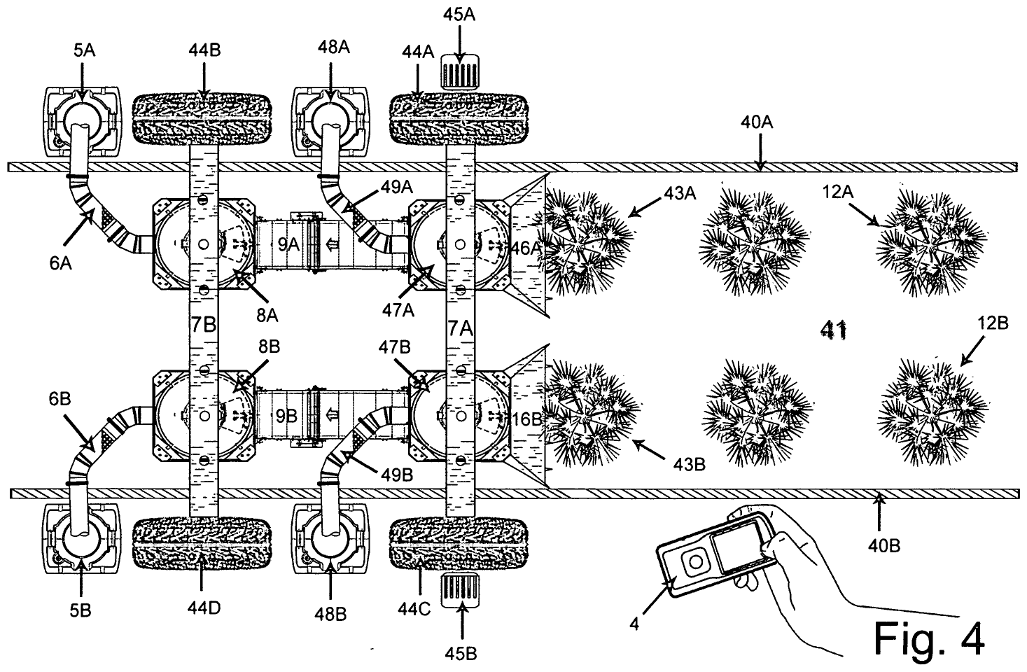

FIG. 4 is a top view of the preferred embodiment of the plant and harvester highlighting the functional components of the invention.

The mechanism of this embodiment is shown to be harvesting from plant bed 41 which has walls 40A and 40B containing two rows of plants 42A and 428. While this illustration shows two rows of crops, the invention is not so limited and as will be shown, is able to address any number of rows.

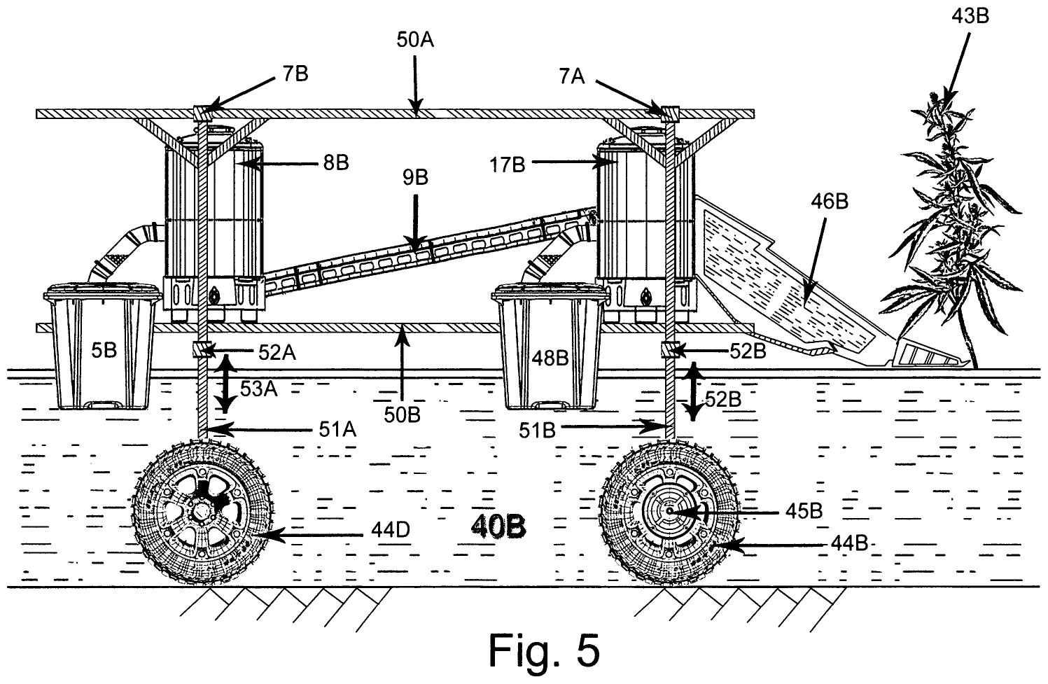

The harvesting mechanism of this embodiment uses two cross members/tool bars 7A and 7B which support the harvesting machinery. The rest of the frame is not shown in this illustration but is further defined in FIG. 5.

The entire mechanism is supported by wheels 44A, 44B, 44C, and 44D which are used to move the mechanism along plant bed 41. Motors 45A and 45B drive wheels 44A and 44B respectively and are controlled by remote control 4 held by the operator.

As the mechanism traverses along plant bed 41, cutters 46A and 16B engage plants 44A and 44B in this illustration. Cutters 44A and 446 cut the stem of the plants which are then passed along to de-flowering mechanism 47A and 47B. De-flowering mechanisms 47A and 47B remove the flowers from the cut stems and transport the flowers to flower bins 48A and 48B via conduits 49A and 49B.

In this embodiment, flower bins 48A and 48B are supported on the sides of the mechanism to facilitate the collection and transport from the growing area.

The deflowered stems are communicated via conduits 9A and 9B to the de-leafing mechanisms 8A and 8B which remove the leaves from the stems. The removed leaves are communicated to leaf bins 5A and 5B via conduits 6A and 6B. The now naked stems are either dropped onto the plant bed 41 or are baled into bunches before being deposited onto the plant bed 41.

In this manner, the plants from a plant bed are mechanically harvested, thereby reducing the man-power associated with the traditional harvesting of a plant bed.

FIG. 5 is a side view of the preferred embodiments illustrating the mechanical structure of the preferred embodiment.

The harvesting mechanism is support by a frame constituting a top horizontal member 50A and a lower horizontal member 50B. The opposing side is not visible but is a replica of this structure.

The top horizontal member 50A, and its counterpart on the left side, support the cross members/tool bars 7A and 7B which are used to support the harvesting mechanisms. The lower horizontal member 50B, with its counterpart on the other side, support the flower bin 48B and the leaf bin 5B.

Legs 51A and 51B engage wheels 44B and 44D and provide support for the frame itself. In this embodiment, legs 51A and 51B include knuckles 52A and 52B which, when loosened, allows legs 51A to be elongated, as indicated by arrows 53A and 53B, so that the frame has the proper height to address plant 43B which depends on the height of wall 40B.

In this way, the frame is adjusted to address the particular plant bed and crop.

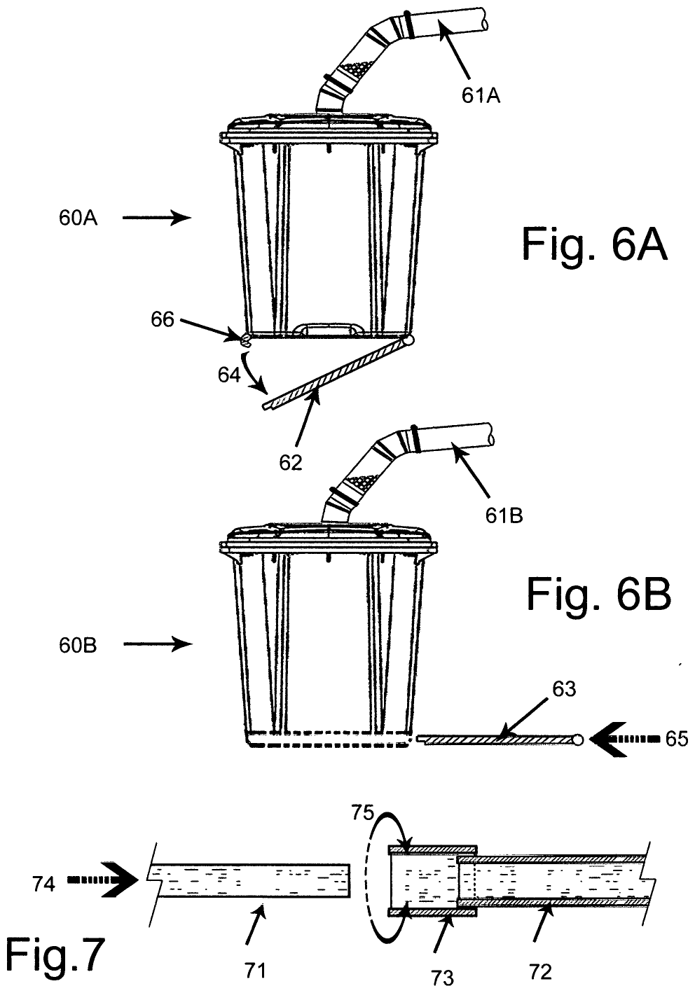

FIGS. 6A and 6B illustrate two alternative bins permitting easy discharge of the collected materials (flowers or leaves).

Referring to FIG. 6A, bin 60A may be used for the collection of the flowers or the leaves in the embodiment above. The leaves or flowers are deposited into bin 60A via conduit 61. Door 62 is latched shut via latch 66. During the discharge of the contents, latch 66 is released allowing door 62 to swing open as indicated by arrow 64.

The contents are collected into a wheeled wagon or the like for transport into the sorting room.

FIG. 6B is an alternative embodiment for the bin. Again bin 60B is loaded via conduit 61B with either flowers or leaves while slide 63 is inserted into bin 60B. For discharge, slide 63 is removed from the bottom of bin 60B allowing the contents to drop into the transport wagon, not shown.

FIG. 7 illustrates a cross member or tool bar that may be elongated. Rod/bar 71 is configured to be accepted inside rod/bar 71 as illustrated by arrow 74 A knuckle 73 is secured to the end of rod/bar 72 and once rod/bar 71 is inserted to the proper depth (thereby defining the elongated length of the combined bar/rod 71 and 72), knuckle 73 is rotated as indicated by arrow 75 to tighten and affix the two bar/rods 71 and 72 to each other.

It is clear that the present invention provides for a highly efficient mechanism to harvest field grown cannabis.

What is claimed is:

1. A harvester for bedded plants comprising:
a) a driving mechanism having two sets of motion mechanisms adapted to engage a flooring, each set of motion mechanisms positioned on opposing sides of a plant bed;
b) a support mechanism being generally “U” shaped having at least two legs and a cross member, a first end of each leg of the support mechanism secured to one of the motion mechanisms with each end of the cross member of the support mechanism secured to a second end of the at least two legs and extending over and parallel to the plant bed;
c) a motor driving said motion mechanisms causing the support mechanism to travel along the flooring; and,
d) a primary harvest mechanism secured to the cross member and having,
1) a gripping mechanism adapted to secure the stems of plants in the plant bed,
2) a cutting mechanism adapted to cut the stems of the plant below a point of contact between the gripping mechanism and a base of the plant, and,
3) a de-flowering mechanism adapted to separate flowers on the cut plant from the stem.

2. The harvester according to claim 1, further including a handheld control adapted to receive operator input for control of the driving mechanism.

3. The harvester according to claim 2, further including a flower bin adapted to receive removed flowers from the de-flowering mechanism.

4. The harvester according to claim 3, wherein the flower bin is secured to the support mechanism exterior to the plant bed.

5. The harvester according to claim 4, wherein the flower bin includes a dump door positioned at the bottom of the flower bin.

6. The harvester according to claim 3, wherein each of the at least two legs are adapted to be elongated.

7. The harvester according to claim 3, wherein the cross member is adapted to be elongated.

8. The harvester according to claim 7, wherein the harvesting mechanism is detachable from the cross member.

9. The harvester according to claim 8, further including at least one secondary harvest mechanisms attachable to the cross member and operating in parallel to the primary harvest mechanism.

10. The harvester according to claim 7, wherein the harvesting mechanism includes, after the deflowering mechanism, a de-leafing mechanism adapted to remove leaves from the stem.

11. The harvester according to claim 10, further including a leaf bin adapted to receive leaves from the de-leafing mechanism.

12. The harvester according to claim 11, wherein the leaf bin is secured to the support mechanism exterior to the plant bed.

13. The harvester according to claim 12, wherein the leaf bin includes a dump door positioned at the bottom of the flower bin.

14. The harvester according to claim 11, further including, after the de-leafing mechanism, a baling mechanism receiving the stems and adapted to package the stems into bundles and deposit onto the plant bed.

15. A harvester for plants in a plant bed arranged in rows comprising:
a) a tractor mechanism having,
1) a driving mechanism having two sets of motion mechanisms adapted to engage a flooring,
2) at least two legs, a first end of each leg secured to one of the motion mechanisms,
3) a tool bar secured to a second end of the at least two legs and extending the plant bed, and,
4) a motor driving said motion mechanisms causing the support mechanism to travel over the flooring; and,
b) at least two harvest mechanisms, each of said harvest mechanisms securable to the tool bar in alignment with a row of bedded plants, each harvest mechanisms having,
1) a gripping mechanism adapted to secure stems of plants in the plant bed,
2) a cutting mechanism adapted to cut the stems of the plant below a point of contact between the gripping mechanism and a base of the plant, and,
3) a de-flowering mechanism adapted to separate flowers on the cut plant from the stem.

16. The harvester according to claim 15, further including a flower bin adapted to receive removed flowers from the de-flowering mechanism, said flower bin secured to the tractor mechanism exterior to the plant bed.

17. The harvester according to claim 16, wherein each harvesting mechanism includes, after the deflowering mechanism, a de-leafing mechanism adapted to remove leaves from the stem and deposit removed leaves into a leaf bin.

18. The harvester according to claim 17, wherein the leaf bin is secured to the tractor exterior to the plant bed

19. A harvest mechanism adapted to be moved through a row of plants in a bed, said harvest mechanism comprising:
a) a gripping mechanism adapted to secure stems of plants in the plant bed;
b) a cutting mechanism adapted to cut the stems of the plant below a point of contact between the gripping mechanism and a base of the plant;
c) a de-flowering mechanism adapted to separate flowers on the cut stem from the stem; and,
d) a flower bin adapted to receive removed flowers.
